(19) United States
(12) Patent Application Publication
(10) Pub. No.: US 2007/0143799 A1
(43) Pub. Date: Jun. 21, 2007

(54) MOBILE TELEVISION GAP FILLER DURING CHANNEL SWITCHING

(75) Inventor: Leland Scott Bloebaum, Cary, NC (US)

Correspondence Address: MOORE AND VAN ALLEN PLLC FOR SEMC, P.O. BOX 13706, 430 DAVIS DRIVE, SUITE 500, RESEARCH TRIANGLE PARK, NC, 27709, US

(73) Assignee: SONY ERICSSON MOBILE COMMUNICATIONS AB, Lund (SE)

(21) Appl. No.: 11/306,267

(22) Filed: Dec. 21, 2005

(51) Int. Cl. H04N 7/16

(52) U.S. Cl. 725/62

(57) ABSTRACT

A mechanism for displaying gap filler data on a display of a portable mobile communications device (PMCD) receiving a mobile broadcast via a mobile broadcast receiver during a time delay occurring as a result of switching from a first channel to a second channel is presented. A PMCD processor detects when a channel switch request is initiated via a user interface. This causes the mobile broadcast receiver to switch from the first channel to the second channel. A media player application receives a signal from a mobile broadcast device signal processor that a channel switch is occurring. The media player application retrieves gap filler data to be displayed during the time delay needed to complete the channel switch. The media player application subsequently receives a signal that the channel switch has completed and discontinues displaying the gap filler data so that the display can display the newly tuned second channel.

### BACKGROUND OF THE INVENTION

The present invention relates to portable mobile communications devices (PMCDs) and systems, and more particularly to a portable mobile communications device, system and method that can receive television broadcast signals.

Portable mobile communications devices such as mobile phones are becoming more sophisticated and include many new features and capabilities. One such feature is the capability to receive mobile broadcast signals, mobile television, or the like. Such services include digital video broadcast-handheld (DVB-H), digital media broadcast (DMB), integrated services digital broadcast-terrestrial (ISDB-T), mobile broadcast multi-cast service (MBMS), or similar technologies. When integrated into a mobile phone, all of the aforementioned technologies utilize a separate mobile broadcast tuner except for MBMS which can be received using the portable mobile communications device existing mobile radio receiver and transmitter.

The DVB-H standard reduces power consumption and extends battery life by using a time sliced format to transfer one of many data channels to a portable mobile communications device. For instance, the radio and demodulator associated with the mobile broadcast portion of the portable mobile communications device are only powered on for relatively short periods of time (i.e., 0.1 seconds) while they remain powered off for longer periods of time (i.e. 1 to 5 seconds). Thus, the ratio between on/off of the radio and demodulator can range from 10:1 to 50:1 while the interval between on cycles can vary from 1.0 to 5.0 seconds.

The drawback to this power save method is that the time required to switch from one channel to another channel is noticeably and annoyingly long for the user/viewer. Conversely, leaving the radio and demodulator powered on all the time to capture and buffer all available channels will drastically affect the battery life of the device.

Currently, there are no provisions addressing the situation described above. What is needed is a means for presenting something other than a blank screen on the display during the extended time gap as a result of retuning the mobile broadcast receiver to a new channel.

### BRIEF SUMMARY OF THE INVENTION

The present invention comprises an apparatus, method, and computer program product for displaying gap filler data on a display of a portable mobile communications device receiving a mobile broadcast via a mobile broadcast receiver during a time delay occurring as a result of switching from a first channel to a second channel. A processor detects when a channel switch request is initiated via a user interface. This causes a mobile broadcast receiver to switch from the first channel to the second channel. A media player application receives a signal from a mobile broadcast device signal processor that a channel switch is occurring. The media player application retrieves gap filler data to be displayed during the time delay needed to complete the channel switch. The media player application subsequently receives a signal that the channel switch has completed and discontinues displaying the gap filler data so that the portable mobile communications device display can show the newly tuned second channel.

### BRIEF DESCRIPTION OF THE DRAWINGS

FIG. 1 is a block diagram of an exemplary portable mobile communications device for presenting something other than a blank screen or the last frame of the previous channel on a mobile display during an extended time gap as a result of retuning the television receiver to a new channel.

FIG. 2 is a timing diagram illustrating the timing involved in switching channels from one mobile broadcast program to another.

FIG. 3 is a flowchart describing interaction between the channel switch delay gap filler application and the mobile television device.

### DETAILED DESCRIPTION OF THE INVENTION

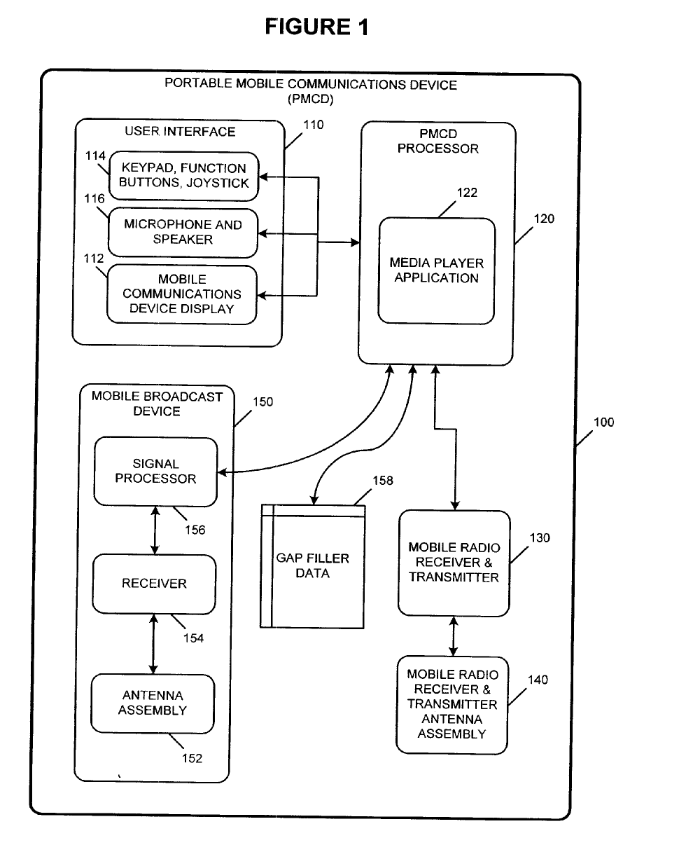

FIG. 1 is a block diagram of an exemplary portable mobile communications device for presenting something other than a blank screen or the last frame of the previous channel on a mobile display during an extended time gap as a result of retuning the television receiver to a new channel. The design of the portable mobile communications device 100 illustrated in FIG. 1 is for purposes of explaining the present invention and the present invention is not limited to any particular design.

The portable mobile communications device 100 may include an operator or user interface 100 to facilitate controlling operation of the portable mobile communications device 100 including initiating and conducting phone calls and other communications. The user interface 100 may include a display 112 to provide visual signals to a subscriber, viewer, or user as to the status and operation of the portable mobile communications device 100. The display 112 may be a liquid crystal display (LCD) or the like capable of presenting color images. The display 112 may provide information to a user or operator in the form of images, text, numerals, characters, a graphical user interface (GUI) and the like. The display 112 may also be used to present programming carried by broadcast mobile television signals.

The user interface 112 may also include a keypad and function keys or buttons 114 including a pointing device, such as a joystick or the like. The keypad, function buttons and/or joystick 114 permit the user to communicate commands to the portable mobile communications device 100 to dial phone numbers, initiate and terminate calls, establish other communications, such as access a mobile television provider, the Internet, send and receive email, text messages and the like. The keypad, function buttons, and/or joystick 114 may also be used to control other operations of the portable mobile communications device 100. The keypad, function buttons, and/or joystick 114 may also be implemented and combined on a touch sensitive display to receive tactile input.

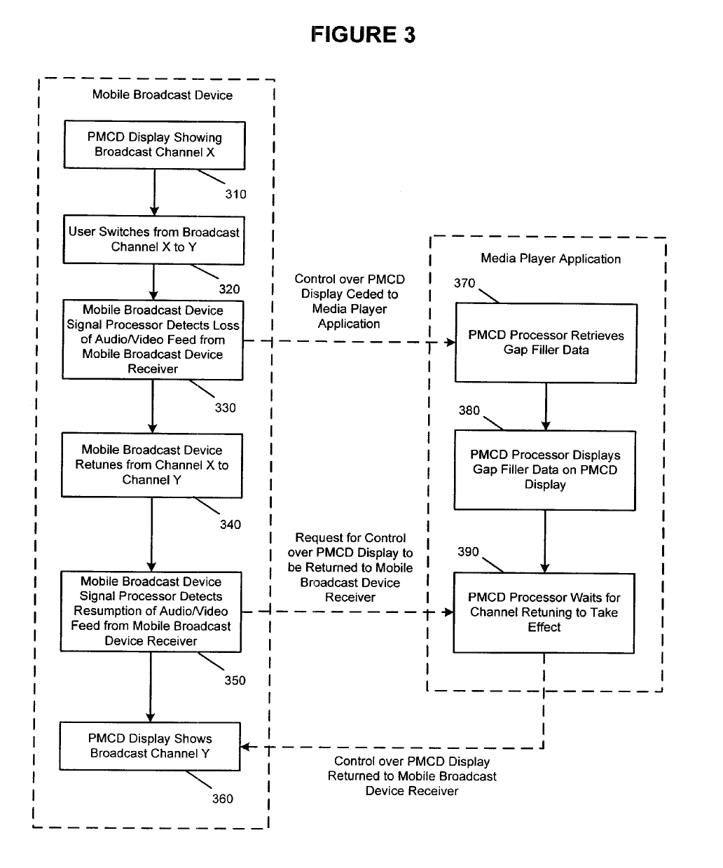

The display 112, keypad, and function buttons 114 may be coupled to a PMCD processor 120. The PMCD processor 120 may be a microprocessor, digital signal processor or the like. The PMCD processor 120 may include a media player application 122 for filling the gap in time during a channel switch. The functions and operations described with respect to a portable mobile communications device 100 in method 300 of FIG. 3 may be embodied in the media player application 122 for filling the gap in time during a channel switch. The media player application 122 may be embodied in hardware, firmware, software (data structures) or combinations thereof. The PMCD processor 120 may also include other data structures, software programs, computer applications and the like to encode and decode control signals; perform communication procedures and other functions as described herein.

With respect to traditional mobile phone functions, the user interface 110 may also include a microphone and a speaker 116. The microphone 116 may receive audio or acoustic signals from a user or from another acoustic source. The microphone 116 may convert the audio or acoustic signals to electrical signals. The microphone 116 may be connected to the PMCD processor 120 wherein the PMCD processor 120 may convert the electrical signals to baseband communication signals. The PMCD processor 120 may be connected to a radio transmitter 130 that may convert baseband signals from the PMCD processor 120 to radio frequency (RF) signals. The radio transmitter 130 may be connected to an antenna assembly 140 for transmission of the RF signals to a communication medium or system, such as a mobile radio access network (MRAN) or the like.

The antenna assembly 140 may receive RF signals over the air and transfer the RF signals to a radio receiver 130. The radio receiver 130 may convert the RF signals to baseband signals. The baseband signals may be applied to the PMCD processor 120 which may convert the baseband signals to electrical signals. The PMCD processor 120 may send the electrical signals to the speaker 116 which may convert the electrical signals to audio signals that can be understood by the user.

The portable mobile communications device 100 may also include a mobile broadcast device 150. The mobile broadcast device 150 may be a DVB-H type device or the like. The mobile broadcast device 150 may be integrally formed as part of the portable mobile communications device 100 or may be a separate unit that may be connected and operate in association with the portable mobile communications device 100. The mobile broadcast device 150 may include an antenna assembly 152 for receiving broadcast signals of programming from a mobile broadcast network, broadcast radio access network (B-RAN) or the like. A receiver 154 may be coupled to the antenna assembly 152 to receive the broadcast signals. A signal processor 156 may receive the broadcast signals from the receiver 154 and convert the signals to a format for video presentation on the display 112 and audio output on speaker 116 of the portable mobile communications device 100.

A gap filler data storage means 158 may also be present to store data to be presented during a channel switch delay. The gap filler data storage means 158 is accessible to the media player application 122. The gap filler data storage means 158 need not be a separate data storage means within the portable mobile communications device 100. It can be virtually any type of memory or data storage common to the portable mobile communications device 100 such as internal memory, or removable storage media such as Memory Stick™, or compact flash card, etc. It has merely been labeled gap filler data storage means 158 for convenience and ease of illustration. The gap filler data itself can be pictures, short video clips, pre-configured content supplied by the mobile network service provider, or user downloaded content. Moreover, the gap filler data need not all reside within the same memory structure. Some gap filler data can be stored internally while other gap filler data can be stored on a removable storage medium.

The DVB-H mobile broadcast standard reduces power consumption and extends battery life by using a time sliced format to transfer one of many data channels to a mobile device. For instance, the radio and demodulator associated with the mobile broadcast receiver 154 of the portable mobile communications device 100 are only powered on for relatively short periods of time (i.e., 0.1 seconds) while they remain powered off for longer periods of time (i.e. 1 to 5 seconds). Thus, the ratio between on/off of the radio and demodulator can range from 10:1 to 50:1 while the interval between on cycles can vary from 1.0 to 5.0 seconds. This results in a significant and annoying lag time when switching channels. The delay between retuning from the old channel to the new channel can be a few seconds.

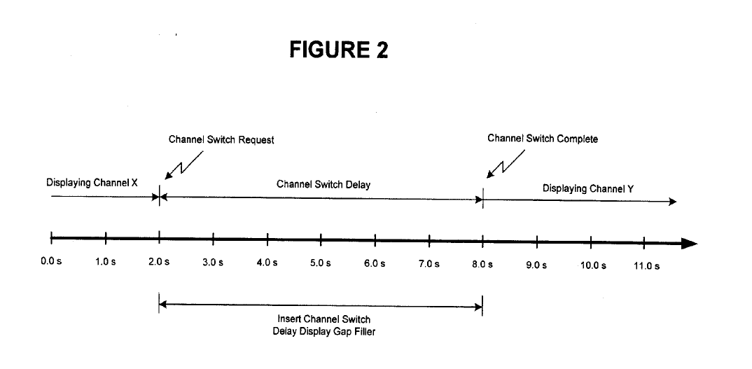

This is illustrated on the timeline of FIG. 2. The mobile broadcast device 150 is camped on and currently displaying channel X. Since the tuner/demodulator are only on for a fraction of time, the mobile broadcast device 150 must wait until the next on cycle in order to perform any commands or instructions initiated by the user/viewer via the user interface. Thus, a channel switch request and execution can take up to 6 seconds according to FIG. 2.

In this timing diagram, the mobile broadcast device receives a request initiated by the user/viewer to switch to channel Y at the two (2) second mark on the timeline. The channel switch request can take up to six seconds to process before the mobile broadcast device is ready to display the content on the newly requested channel. During this time the portable mobile communications device will display an alternate content data source. The alternate content data source is designed to occupy the user's interest or accomplish a goal of a service provider while the channel switch takes place. The alternate content data source is of more interest to the user than a blank screen or last frame of the previous channel would be during the time needed to carry out the channel switch.

FIG. 3 is a flowchart describing interaction between the media player application and the mobile broadcast device. In block 310, the mobile broadcast device is displaying the content on channel X. In block 320, the user decides to switch to channel Y and initiates a channel switch with the mobile broadcast receiver. In block 330, the mobile broadcast receiver detects a loss of the television signal due to the retuning by the mobile broadcast receiver. This cedes control of the portable mobile communications device display to the media player application while the mobile broadcast receiver retunes from channel X to channel Y in block 340. In block 350, the mobile broadcast receiver monitors the progress of the channel switch request until the mobile broadcast receiver signal processor detects a resumption of the broadcast signal following completion of the channel switch and sends a request to the media player application to return control of the portable mobile communications device display to the mobile broadcast receiver. In block 360, the portable mobile communications device displays the content broadcast by channel Y.

During the retuning period between the request to switch from channel X to Y and the actual retuning to channel Y, control of the portable mobile communications device display is ceded to the media player application. In block 370, the media player application retrieves gap filler data. In block 380, the media player application displays the retrieved gap filler data. In block 390, the media player application then waits for a request to return control of the portable mobile communications device display to the mobile broadcast receiver upon successful retuning from channel X to channel Y.

The gap filler data can be pre-stored digital video stills, motion clips, or animation that would play during the channel switch delay. The gap filler data can be locally stored on the portable mobile communications device or stored on a removable storage medium. For instance, a slide show of still images stored in a specific file folder could be shown. Similarly, the media player application could point to and retrieve a video clip or animation stored in a specific file folder.

The increments and intervals shown in FIG. 2 are illustrative in nature and not intended to restrict the present invention in any way. Other mobile television devices may use smaller or larger time intervals between power on cycles of the tuner/demodulator portion of the mobile television device.

As will be appreciated by one of skill in the art, the present invention may be embodied as a method, system, or computer program product. Accordingly, the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the present invention may take the form of a computer program product on a computer-usable storage medium having computer-usable program code embodied in the medium.

Any suitable computer readable medium may be utilized. The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a transmission media such as those supporting the Internet or an intranet, or a magnetic storage device. Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory. In the context of this document, a computer-usable or computer-readable medium may be any medium that can contain, store, communicate, propagate, or transport the program for use by or in connection with the instruction execution system, apparatus, or device.

Computer program code for carrying out operations of the present invention may be written in an object oriented programming language such as Java, Smalltalk, C++ or the like. However, the computer program code for carrying out operations of the present invention may also be written in conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through a local area network (LAN) or a wide area network (WAN), or the connection may be made to an external computer (for example, through the Internet using an Internet Service Provider).

The present invention may have been described with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable memory that can direct a computer or other programmable data processing apparatus to function in a particular manner, such that the instructions stored in the computer-readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

The flowcharts and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems which perform the specified functions or acts, or combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Although specific embodiments have been illustrated and described herein, those of ordinary skill in the art appreciate that any arrangement which is calculated to achieve the same purpose may be substituted for the specific embodiments shown and that the invention has other applications in other environments. This application is intended to cover any adaptations or variations of the present invention. The following claims are in no way intended to limit the scope of the invention to the specific embodiments described herein.

What is claimed is:

1. A method of displaying gap filler data on a display of a portable mobile communications device capable of receiving a mobile broadcast via a mobile broadcast receiver during a time delay occurring as a result of switching the mobile broadcast receiver from a first channel to a second channel, the method comprising:
receiving a signal initiated from a user interface of the portable mobile communications device into a mobile broadcast device signal processor that causes the mobile broadcast receiver to switch channels from the first channel to the second channel;
retrieving the gap filler data;
displaying the gap filler data on the display during the mobile broadcast receiver channel switching process; and
discontinuing displaying of the gap filler data in favor of displaying the second channel upon successful completion of the channel switching process.

2. A portable mobile communications device for displaying gap filler data on a display of the portable mobile communications device capable of receiving a mobile broadcast via a mobile broadcast receiver during a time delay occurring as a result of switching the mobile broadcast receiver from a first channel to a second channel, the portable mobile communications device comprising:
a mobile broadcast receiver for receiving a mobile broadcast of multiple channels of content data;
a display for displaying the mobile broadcast and the gap filler data;
a mobile broadcast device signal processor for detecting when a channel switch request is initiated via a user interface and causing the mobile broadcast receiver to switch from the first channel to the second channel; and
a media player application executing on a processor within the portable mobile communications device and communicable with the mobile broadcast device signal processor for inserting the gap filler data during the time delay needed to complete the channel switch from the first channel to the second channel.

3. The portable mobile communications device of claim 2 wherein the media player application:
receives a signal from the mobile broadcast device signal processor that a channel switch from the first channel to the second channel has been initiated;
retrieves the gap filler data that is to be displayed during the time delay needed to complete the channel switch from the first channel to the second channel;
receives a signal from the mobile broadcast device signal processor that the channel switch from the first channel to the second channel has completed; and
discontinues displaying the gap filler data so that the display can display the newly tuned second channel.

4. The portable mobile communications device of claim 3 wherein the gap filler data is locally stored on the portable mobile communications device.

5. The portable mobile communications device of claim 4 wherein the gap filler data is a still image.

6. The portable mobile communications device of claim 4 wherein the gap filler data is a video clip.

7. The portable mobile communications device of claim 4 wherein the gap filler data is an animation clip.

8. The portable mobile communications device of claim 3 wherein the gap filler data is stored on a removable storage medium that can be coupled with the portable mobile communications device.

9. A computer program product embodied on a computer readable storage medium for displaying gap filler data on a display of a portable mobile communications device capable of receiving a mobile broadcast of multiple channels via a mobile broadcast receiver during a time delay occurring as a result of switching the mobile broadcast receiver from a first channel to a second channel, the computer program product comprising:
computer program code for detecting when a channel switch request is initiated via a user interface and causing the mobile broadcast receiver to switch from the first channel to the second channel; and
computer program code for inserting the gap filler data during the time delay needed to complete the channel switch from the first channel to the second channel.

10. The computer program product embodied on a computer readable storage medium of claim 9 further comprising:
computer program code for receiving a signal that a channel switch from the first channel to the second channel is occurring;
computer program code for retrieving the gap filler data that is to be displayed during the time delay needed to complete the channel switch from the first channel to the second channel;
computer program code for receiving a signal that the channel switch from the first channel to the second channel has completed; and
computer program code for discontinuing displaying the gap filler data so that the display can display the second channel.

11. The computer program product embodied on a computer readable storage medium of claim 10 wherein the gap filler data is locally stored on the portable mobile communications device.

12. The computer program product embodied on a computer readable storage medium of claim 11 wherein the gap filler data is a still image.

13. The computer program product embodied on a computer readable storage medium of claim 11 wherein the gap filler data is a video clip.

14. The computer program product embodied on a computer readable storage medium of claim 11 wherein the gap filler data is an animation clip.

15. The computer program product embodied on a computer readable storage medium of claim 10 wherein the gap filler data is stored on a removable storage medium.
